(19) United States
(12) Patent Application Publication
(10) Pub. No.: US 2014/0333598 A1
(43) Pub. Date: Nov. 13, 2014

(54) Display Apparatus Incorporating Varying Threshold Voltage Transistors

(71) Applicant: Pixtronix, Inc., San Diego, CA (US)

(72) Inventors: Jianru Shi, Haverhill, MA (US); Stephen R. Lewis, Reading, MA (US); Mark B. Andersson, Northnorough, MA (US); Cait Ni Chleirigh, Arlington, MA (US)

(73) Assignee: Pixtronix, Inc., San Diego, CA (US)

(21) Appl. No.: 13/891,995

(22) Filed: May 10, 2013

(51) Int. Cl. G09G 3/36

(52) U.S. Cl. CPC G09G 3/3696
USPC 345/212

(57) ABSTRACT

This disclosure provides systems, methods and apparatus for controlling pixels of a display apparatus. An apparatus including a plurality of pixels can be controlled by a control matrix. The control matrix includes for each pixel a first transistor that has a first threshold voltage and a second transistor that has a second threshold voltage. A single data interconnect provides a common data voltage to the first and second transistors to control the states of corresponding first and second light modulators.

### TECHNICAL FIELD

This disclosure relates to the field of displays, and in particular, to circuits for controlling the states of light modulators incorporated into displays.

### DESCRIPTION OF THE RELATED TECHNOLOGY

Various display architectures have been proposed that include two or more light modulators for each display pixel. Circuitry for controlling such display architectures can quickly begin to take up an unacceptable amount of area on a substrate as separate control lines and other circuit components are often used to convey actuation instructions to each actuator.

In addition, to reduce power consumption in display circuits, it is desirable to enable certain switches to change states in response to relatively small voltage variations. At the same time, such circuits include other switches which preferably require greater voltage swings to change states to ensure reliable operation.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes an array of pixels and a control matrix coupled to the array of pixels. Each pixel includes a plurality of light modulators. The control matrix includes for each pixel a first transistor and a second transistor. The first transistor has a first threshold voltage governing actuation of a first light modulator of the plurality light modulators in the pixel. The second transistor has a second threshold voltage, which is different than the first threshold voltage, and governs actuation of a second light modulator of the plurality light modulators in the pixel. The control matrix also includes a single data interconnect for each pixel that provides a common data voltage to corresponding gates of both the first and second transistors. In some implementations, the first and second light modulators include electromechanical systems (EMS) shutters which are configured to move relative to separate apertures formed in a light blocking layer.

In some implementations, the application of a data voltage greater than the first threshold voltage and less than the second threshold voltage causes the actuation or discharge of the first light modulator but not the second light modulator. In some implementations, the application of a data voltage greater than the first and second threshold voltages causes the actuation or discharge of both the first and second light modulators.

In some implementations, for a given pixel, the first transistor is included in a first sub-pixel circuit and the second transistor is included in a substantially identical second sub-pixel circuit. In some such implementations the control matrix also includes an actuation interconnect coupled to the first and second sub-pixel circuits. In some implementations, at least one of the data interconnect and the actuation interconnect passes between the first and second sub-pixel circuits.

In some implementations, the first transistor includes a gate formed at a first metal layer of the control matrix and the second transistor includes a gate formed at a second metal layer of the control matrix other than the first metal layer. In some implementations, at least one of the first and second transistors includes a dual-gate metal oxide transistor, and the difference between the first threshold voltage and the second threshold voltage is based on a voltage applied to one of the gates of the dual gate metal oxide transistor. In some other implementations, the length to width ratio of a channel included in the first transistor is substantially different than a length to width ratio of a channel included in the second transistor.

In some implementations, the apparatus also includes a display, a processor, and a memory device. The display includes the array of pixels. The processor can be configured to communicate with the display and to process image data. The memory device can be configured to communicate with the processor. In some implementations, the apparatus also includes a driver circuit configured to send at least one signal to the display and a controller configured to send at least a portion of the image data to the driver circuit. In some implementations, the apparatus also includes an image source module configured to send the image data to the processor. The image source module can include at least one of a receiver, transceiver, and transmitter. In some other implementations, the apparatus includes an input device configured to receive input data and to communicate the input data to the processor.

Another innovative aspect of the subject matter described in this disclosure can be implemented in an apparatus that includes an array of display elements and a control matrix coupled to the display elements. The control matrix includes for each display element, a first transistor having a first threshold voltage governing application of an actuation voltage to the display element and a second transistor having a second threshold voltage, lower than the first threshold voltage, governing discharge of the actuation voltage from the display element.

In some implementations, the control matrix includes an actuation voltage interconnect coupled to the drain and the gate of the first transistor. In some other implementations, the control matrix includes for each display element a data storage capacitor configured to store a data voltage received via a data interconnect for controlling the state of the second transistor.

In some implementations, the first transistor includes a gate formed at a first metal layer of the control matrix and the second transistor includes a gate formed at a second metal layer of the control matrix other than the first metal layer. In some other implementations, at least one of the first and second transistors includes a dual-gate metal oxide transistor. In some such implementations, the difference between the first threshold voltage and the second threshold voltage is based on a voltage applied to one of the gates of the dual gate metal oxide transistor. In some implementations, the length to width ratio of a channel included in the first transistor is substantially different than a length to width ratio of a channel included in the second transistor.

Another innovative aspect of the subject matter described in this disclosure can be implemented in a method of controlling a display apparatus pixel. The method includes receiving a first data signal having a first magnitude at a pixel circuit of a display apparatus. The pixel circuit includes a first transistor having a first threshold voltage governing the state of a first display element and a second transistor having a second threshold voltage governing the state of a second display element. In some implementations, the second threshold voltage is about twice the first threshold voltage. The method includes, in response to the first magnitude exceeding the first threshold voltage, but not the second threshold voltage, changing a state of the first display element and maintaining a state of the second display element. A second data signal having a second magnitude is received at the pixel circuit. In response to the second magnitude exceeding the second threshold voltage, the method includes changing the states of the first and second display elements. In some implementations, receiving the first and second data signals includes receiving the first and second data signals on a single data interconnect.

In some implementations, the method also includes receiving at the first pixel an actuation voltage. In such implementations, the magnitude of the received data voltage selectively governs the application or discharge of the actuation voltage to the first and second display elements.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCD), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIG. 2 shows an example MEMS shutter assembly.

FIG. 3A shows a schematic diagram of an example control matrix.

FIG. 3B shows a schematic diagram of an example pixel circuit suitable for incorporation into the control matrix shown in FIG. 3A.

FIG. 4A shows a schematic diagram of another example pixel circuit.

FIG. 4B shows a schematic diagram of another example control matrix suitable for incorporating the pixel circuits shown in FIG. 4A.

FIG. 5A shows a schematic diagram of another example pixel circuit.

FIG. 5B shows an example control matrix formed from an array of the pixel circuits shown in FIG. 5A.

FIGS. 6A-6C show various views of example transistor architectures.

FIG. 7 shows a flow diagram of an example method 700 of controlling a pixel of a display apparatus

FIGS. 8 and 9 show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, display apparatus can be fabricated to include multiple light modulators per display pixel. The states of each of the light modulators in a given pixel can be controlled using a single common data interconnect and a common data signal by providing transistors having different threshold voltages to control each of the respective light modulators in the pixel. The common data signal is applied to the gates of such transistors, and the number of light modulators in that pixel that actuate depends on the value of the data voltage in comparison to the threshold voltages of the transistors associated with the respective light modulators.

In some other implementations, a circuit for governing an individual light modulator can include transistors having different threshold voltages. For example, a transistor governing the application of a relatively higher actuation voltage can be configured to have a threshold voltage that is higher than a transistor controlled by a relatively lower, and more frequently switched, data voltage signal.

Particular implementations of the subject matter described in this disclosure can be implemented to realize one or more of the following potential advantages. By including multiple light modulators in a display pixel, multiple grayscale states can be derived in a single image sub-frame, reducing the number of image subframes needed to generate a given grayscale value. Doing so can lead to lower power operation of a display because the display's light source can operate at a higher duty cycle, allowing for more energy efficient illumination. It also reduces the number of data addressing cycles needed to form a given image, further reducing power consumption. Moreover, the time saved by displaying fewer image subframes can provides more time to employ various image artifact reduction techniques.

By controlling the multiple light modulators in each pixel using a common data signal coupled to transistors having different threshold voltages, the number of interconnects needed to control the light modulators can be reduced. This preserves valuable space on the substrate for other circuitry, additional light modulators, or increased aperture ratios.

Controlling the application of an actuation voltage to one or more light modulators with a transistor having a higher threshold voltage than a transistor governed by a data signal provides for more reliable, lower-power operation. More particularly, by using a lower threshold voltage transistor to respond to data voltages, lower voltage data signals can be employed. As such signals can be switched several hundred times per image frame, reducing this voltage swing can have a significant impact on power savings. At the same time, preserving a somewhat higher threshold voltage on the less frequently switched transistors controlled by an actuation voltage ensures reliable switching of such transistors.

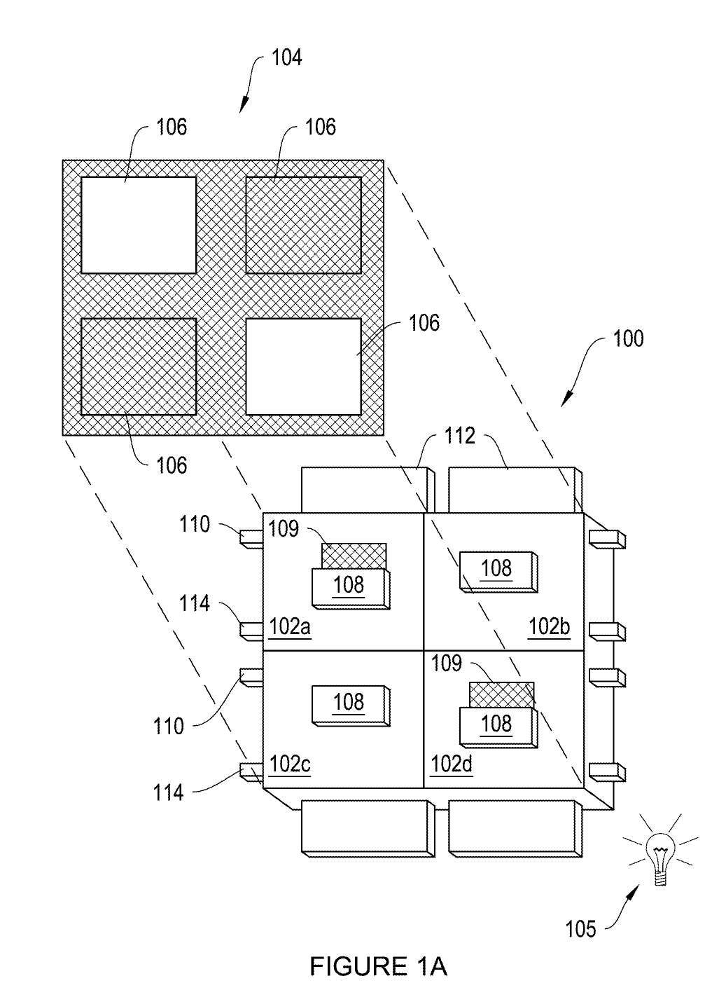

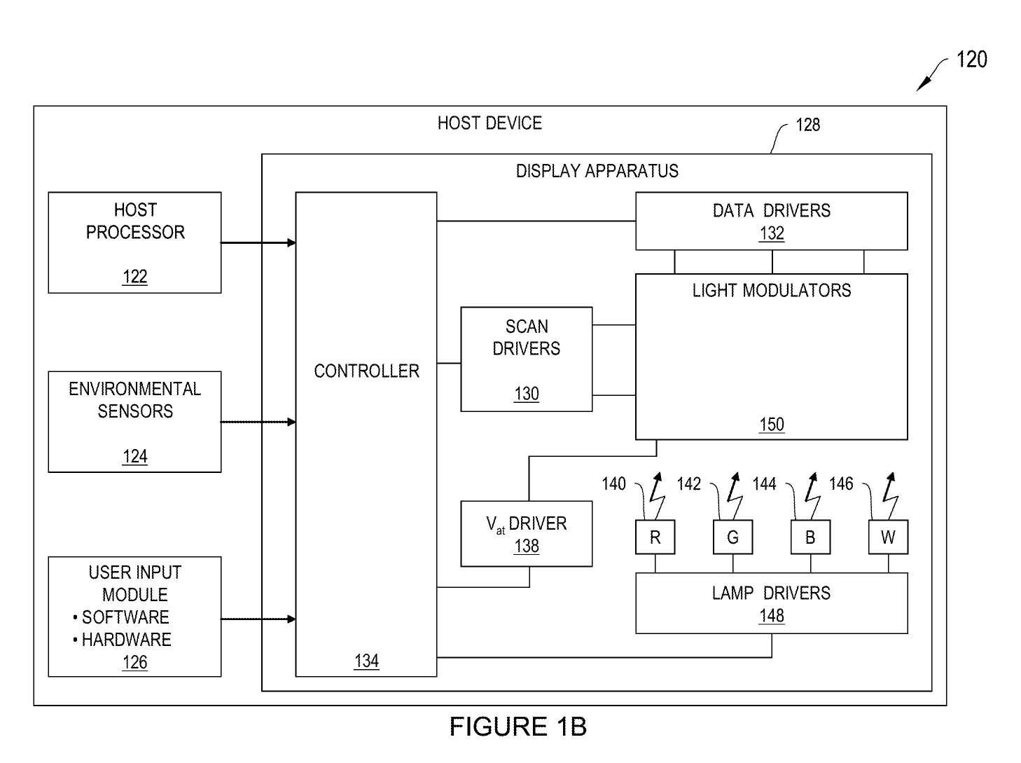

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (such as interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (such as scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division grayscale, as previously described. In some other implementations, the display apparatus 100 can provide grayscale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a scan-line interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

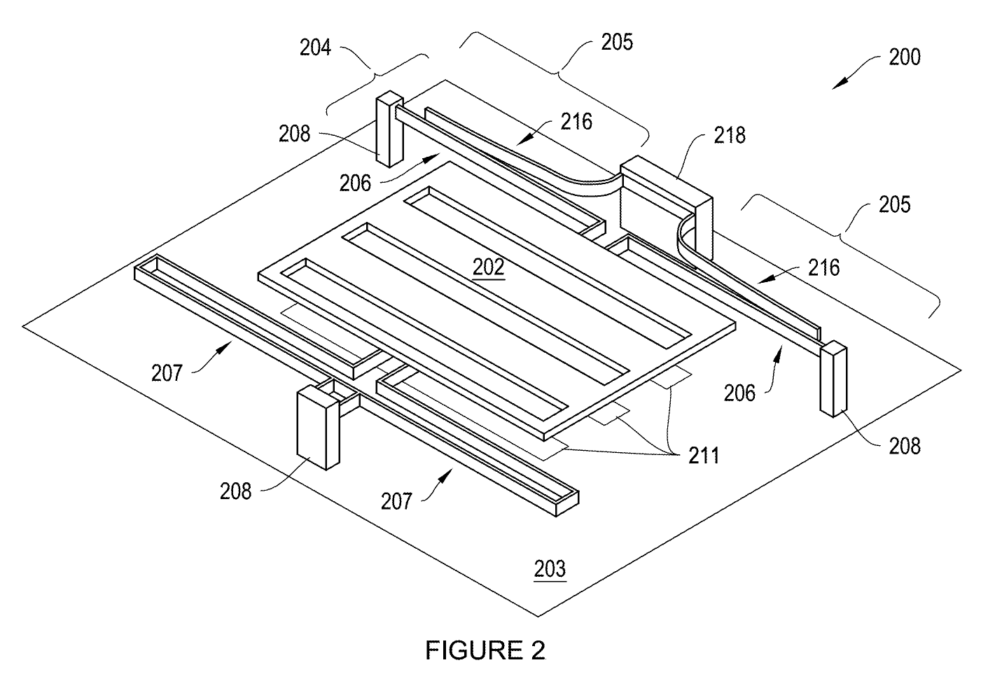

FIG. 2 shows a perspective view of an example shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface 203 includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the aperture holes 211 are formed in a layer of light-blocking material deposited on the substrate 203. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and a separate set of “open” and “closed” electrodes for moving the shutter into either an open or a closed state.

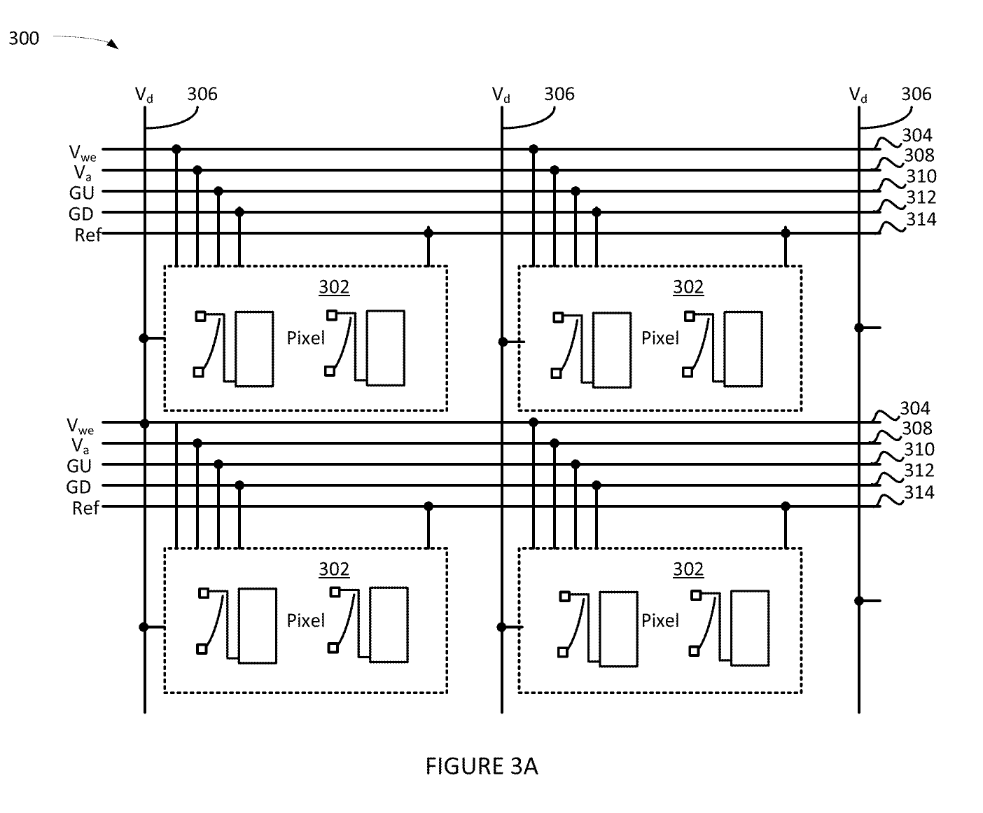

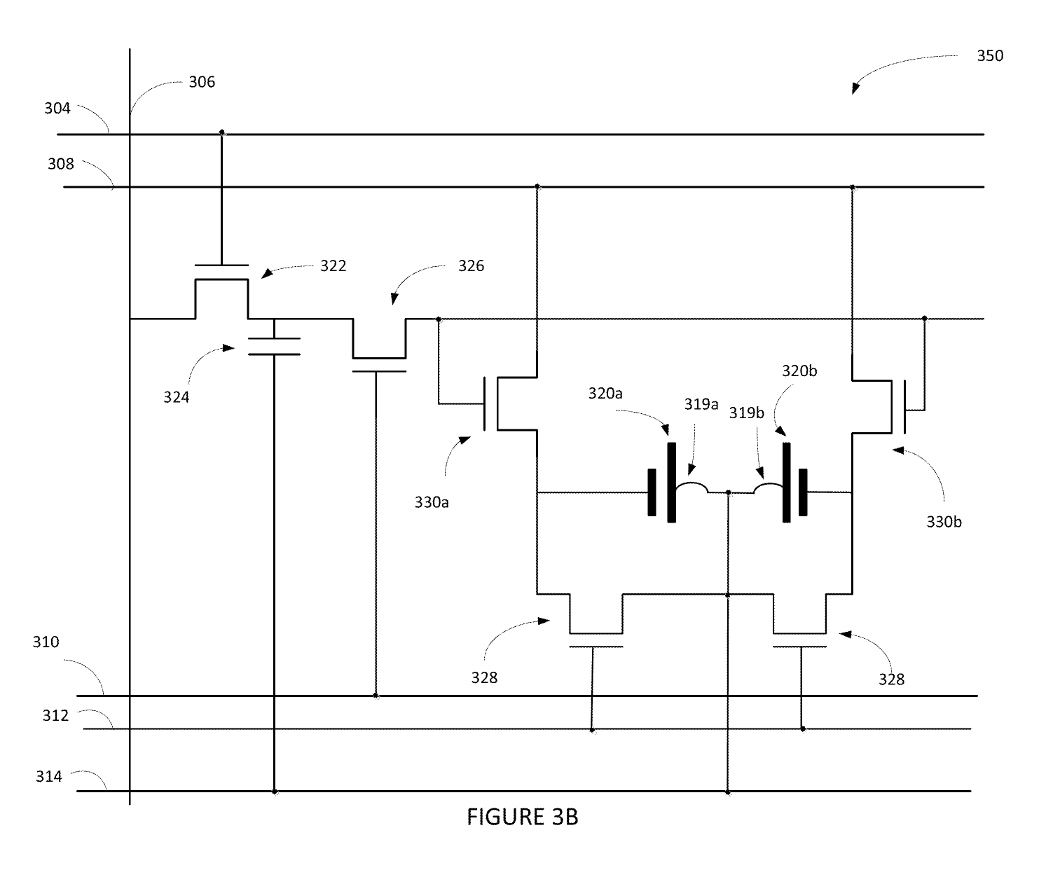

FIG. 3A shows a schematic diagram of an example control matrix 300. As used herein, a control matrix refers to the set of circuitry incorporated into a display used to address and drive the pixels 302 of the display. In general, the control matrix 300 includes components that are shared by multiple pixels 302 and components that are dedicated to each pixel 302. The collection of components dedicated to a pixel is referred to herein as a pixel circuit. FIG. 3B shows a schematic diagram of an example pixel circuit 350 suitable for incorporation into the control matrix 300 shown in FIG. 3A. In some implementations, the control matrix can be fabricated to include various types of thin-film transistors (TFTs), including amorphous-silicon (a-Si), low-temperature poly-silicon (LTPS), indium gallium zinc oxide (IGZO) (or other conductive oxide) TFTs.

More particularly, the control matrix 300 includes scan-line interconnects 304, data interconnects 306, an actuation interconnect 308, a global update interconnect 310, global discharge interconnects 312, and a reference voltage interconnect 314. In some implementations, each scan line interconnect 304 is shared by all the pixels 302 of a given row and each data interconnect is shared by every pixel 302 in a given column of the display. The global update interconnect 310, the global discharge interconnect 312, and the reference voltage interconnect 314 are coupled to pixels 302 in multiple rows and multiple columns of the display. In some implementations, the global update interconnect 310, the global discharge interconnect 312, and the reference voltage interconnect 314 are coupled to all of the pixels 302 in the display.

In some implementations, to reduce the capacitances of various interconnects, the control matrix 300 can be broken down in two regions, for example, display quadrants. In such implementations, each scan line interconnect 304 may be coupled to all pixels 302 in a row in its corresponding region. Similarly, each data interconnect 306 may couple to all of the pixels in a given column in the region. The operation and function of each of the above interconnects is described below in relation to the discussion of the pixel circuit 350.

Referring to FIGS. 3A and 3B, the pixel circuit 350 is configured for controlling two light modulators 320a and 320b per pixel. The pixel circuit 350 includes a write-enabling transistor 322, a data storage capacitor 324, a global update transistor 326, two global discharge transistors 328, and two actuation transistors: a first actuation transistor 330a and a second actuation transistor 330b. FIG. 3B also shows the scan-line interconnect 304, data interconnect 306, actuation interconnect 308, global update interconnect 310, global discharge interconnect 312, and the reference voltage interconnect 314 shown in FIG. 3A to illustrate how these shared interconnects couple to the components of the pixel circuit 350.

The pixel circuit 350 is configured to receive and respond to a data voltage applied to the data interconnect 306 and stored on the data storage capacitor 324. The data voltage stored on the data capacitor 324 can be one of three possible voltages, such as 0V, Vx, and Vy, with Vx being less than Vy. In some implementations, Vy may be greater than or equal to about twice the value of Vx. For example, Vx may be voltage in the range of about 1.5V to about 3V and Vy may be a voltage from about 3V to about 6V. In response to a data voltage of about 0V, neither light modulator 320a or 320b actuates. In response to a data voltage of about Vx, the light modulator 320a actuates, but the other light modulator 320b does not. In response a data voltage of about Vy, both light modulators 320a and 320b actuate.

In more detail, the scan-interconnect 304, the write-enabling transistor 322, the data storage capacitor 324 and the data interconnect 306 are together configured to store a data voltage on the pixel circuit 350. The scan-line interconnect 304 couples to the gate of the write-enabling transistor 322. The drain of the write-enabling transistor 322 couples to the data interconnect 306, and the source of the write-enabling transistor 322 couples to the data storage capacitor 324. In operation, a display loads data into its pixels one row at a time. To do so, a scan driver (such as the scan driver 130 shown in FIG. 1B) raises the voltage on the scan-line interconnect 304 corresponding to a given row to a write-enabling voltage V_{we}, which exceeds the threshold voltage of the write-enabling transistor 322. This turns ON the write-enabling transistors 322 of all pixels 302 in a given row. While the write-enabling transistor 322 is ON, a data voltage is applied to each data interconnect 306. At a given pixel circuit 350, the data voltage on the data interconnect 306 coupled to the pixel circuit 350 causes a current to flow through the write-enabling transistor 322 until the data storage capacitor 324 is brought up to about the data voltage. The voltage on the scan-line interconnect 304 is then brought low again, isolating the charge, and thus substantially maintaining the voltage, on the data storage capacitor 324.

The global update transistor 326 and the actuation transistors 330a and 330b are configured to respond to the data voltage stored on the data storage capacitor 324. More particularly, the gate of the global update transistor 326 is coupled to the global update interconnect 310, with its drain coupled to the gates of the actuation transistors 330a and 330b, and its source coupled to data storage capacitor 324. The sources of the actuation transistors 330a and 330b are coupled to the actuation interconnect 308. Their respective drains are coupled to the light modulators 320a and 320b. The actuation transistors 330a and 330b are configured to have different threshold voltages. For example, similar to as described above, the first actuation transistor 330a can be configured to have a threshold voltage of about Vx, while the second actuation transistor 330b can be configured to have a threshold voltage of about Vy. Accordingly, as described above, depending on the voltage stored on the data capacitor 324, one, none, or both of the actuation transistors 330a and 330b will turn ON.

The global discharge transistors 328 are configured to drain an actuation voltage that may have been applied to the light modulators 320a and 320b. Accordingly, the source of each of the global discharge transistors 328 is coupled to a corresponding light modulator 320a or 320b, their drains are coupled to the reference voltage interconnect 314, and their gates are coupled to the global discharge interconnect 312. Upon application of an appropriate voltage to the global discharge interconnect 312, the global discharge transistors 328 are turned ON. This causes current to flow through the global discharge transistors 328 until the voltages on the light modulators 320a and 320b are brought to the voltage of the reference voltage interconnect 314, for example, ground or a negative voltage. In some implementations, the reference voltage may be as low as −20V or potentially even lower. Upon the reduction of the voltages across the light modulators 320a and/or 320b, the light modulators are able to return, if necessary, to their inactive, or unactuated state, for example, by passive return springs 319a and 319b.

In response to either the first or second actuation transistors 330a or 330b turning ON, their corresponding light modulators 320a and/or 320b will be exposed to the actuation voltage applied to the actuation interconnect 308. The application of the actuation voltage causes the light modulator(s) to change state into an active state. In some implementations, the active state can be a bright state. For example, for displays incorporating shutter-based light modulators, the actuation voltage can move a shutter into a position in which it no longer obstructs the passage of light through an aperture. For displays incorporating reflective light modulators, the application of the actuation voltage can place the light modulator into a reflective state. In some other implementations, the active state can be a dark (for example, light obstructing or light absorbing) state.

Upon application of a voltage to the global update transistor 326, the data voltage is transferred to the gates of both of the actuation transistors 330a and 330b. The actuation transistors 330a and 330b are configured to have different threshold voltages. Specifically, the actuation transistor 330a is configured to have a threshold voltage of about Vx, and the actuation transistor 330b is configured to have a threshold voltage of about Vy. As a result, if the voltage stored on the data storage capacitor 324 is 0, both actuation transistors 330a and 330b remain OFF. If the data voltage stored on the data storage capacitor 324 is greater than or equal to about Vx but less than about Vy, the actuation transistor 330a switches ON, but the actuation transistor 330b remains OFF. If the data voltage stored on the data storage capacitor 324 is greater than or equal to about Vy, both actuation transistors 330a and 330b turn ON.

A constant actuation voltage is applied to the actuation interconnect 308, which is coupled to the sources of the actuation transistors 330a and 330b. Thus, if either or both of the actuation transistors 330a or 330b are turned ON, an actuator included a light modulator 302a or 302b coupled to the corresponding actuation transistor(s) 330a or 330a and 330b actuates, placing the light modulator(s) 302a or 302a and 302b into the active state. The light modulator(s) then remain in that state until the global discharge transistors 310 are turned ON, discharging any voltage stored on the light modulators 302a and 302b, and returning the light modulator(s) to the inactive state.

In some other implementations, the pixel circuit 350 can be modified to allow for the incorporation of polarity reversals into the addressing process. For example, in some implementations, the drains of the global discharge transistors 328 are coupled to ground. In such implementations, the voltage applied to the reference voltage interconnect 314 is varied between ground and the actuation voltage, frame-by-frame, or at some other interval. In addition, when the modified pixel circuit is operating with the reference voltage set to the actuation voltage, the data voltage associated with each light modulator states is inverted with respect to the data voltages used when the reference voltage is set to ground. For example, in some implementations, when the reference voltage is set to ground, a high data voltage results in a light modulator achieving a first state and a low voltage results in the light modulator achieving a second state. When the reference voltage is set to the actuation voltage, the high voltage results in the light modulator achieving the second state and the low voltage results in the light modulator achieving the first state. Such a polarity reversal scheme helps reduce charge building up on the actuators included in the pixel.

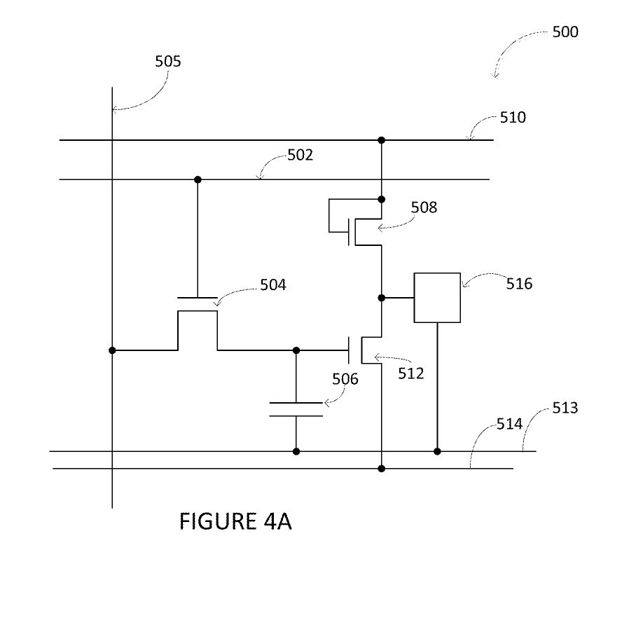

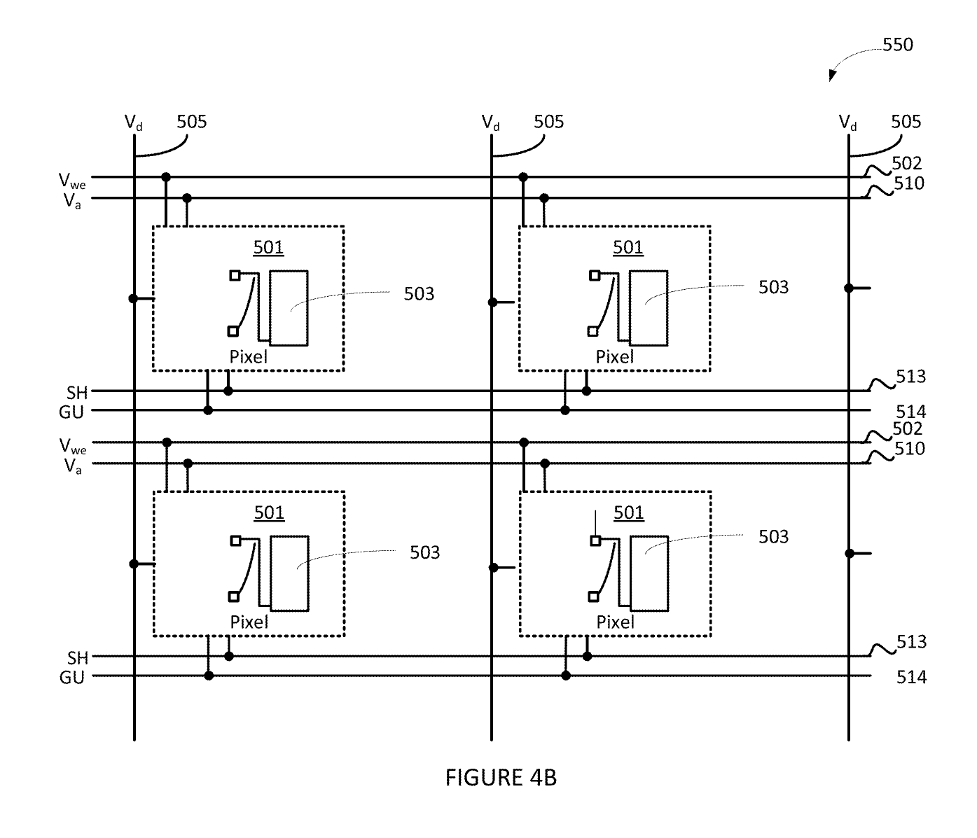

FIG. 4A shows a schematic diagram of another example pixel circuit 500. The pixel circuit 500 includes a scan line interconnect 502, a data interconnect 505, a write-enabling transistor 504, a data storage capacitor 506, a charge transistor 508, and actuation voltage interconnect 510, a discharge transistor 512, a common shutter interconnect 513 and a global actuation interconnect 514.

In brief overview, the pixel circuit 500 is addressed by a voltage being applied to the scan-line interconnect 502 and a data voltage being applied to the data interconnect 505. The data voltage passes through the write-enabling transistor 504 and is stored on the data storage capacitor 506. To actuate a light modulator 516 coupled to the pixel circuit 500, an actuation voltage is applied to the actuation voltage interconnect 510, which turns on the charge transistor 508, storing an actuation voltage on the light modulator 516. When a voltage on the global actuation interconnect 514 is dropped, the discharge transistor 512 is able to respond to the data voltage stored on the data storage capacitor 506, thereby selectively discharging the voltage stored on the light modulator 516, and allowing the light modulator 516 to change states. The common shutter interconnect 513 merely serves to provide a reference voltage for the data storage capacitor 506 and an actuator incorporated into the light modulator 516.

FIG. 4B shows a schematic diagram of another example control matrix 550 suitable for incorporating the pixel circuit 500 shown in FIG. 4A. The control matrix 550 is coupled to array of pixels 501, each of which includes a light modulator 503. The state of each pixel 501 is governed by a pixel circuit having the architecture shown in FIG. 4A. The pixels 501 controlled by the control matrix 550 are arranged in rows and columns. The pixels 501 in a given row share a scan-line interconnect 502 and pixels 501 in a given column share a data interconnect 505. Pixels 501 in multiple rows and multiple columns may share a single actuation voltage interconnect 510, the common shutter interconnect 513, and a single global actuation interconnect 514.

Referring to both FIGS. 4A and 4B, in operation, the control matrix 550 is addressed one row at a time. As such, for a typical display that includes hundreds of rows of pixels 501, the voltage on the data interconnect 505 may need be switched hundreds of times per image frame (or many times that number for displays that present multiple subframes per image frame to implement a time division grayscale image formation process). To reduce power consumption, it is desirable to require a relatively small voltage swing on the data interconnect 505 to control the discharge transistor 512. Thus, it is desirable for the discharge transistor 512 to have a relatively low threshold voltage, making it responsive to smaller voltage swings.

In contrast, the actuation voltage may be applied via the actuation voltage interconnect 510 simultaneously to all light modulators 516, and thus may only need to be switched at most once per image frame (or subframe). In addition, as the charge transistor 508 is triggered by the voltage on the actuation voltage interconnect 510, which is substantially higher than the data voltage used to address the pixel, it is feasible for the charge transistor 508 to have a higher threshold voltage, providing increased reliability in switching, while only incrementally increasing the power consumption of the display. Accordingly, in some implementations, the charge transistor 508 may have a threshold voltage of about 5V whereas the data voltage may have a threshold voltage of about 3V.

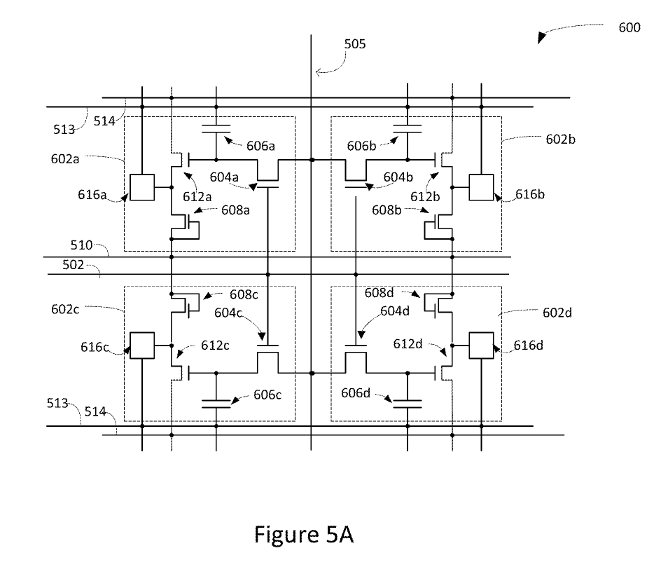

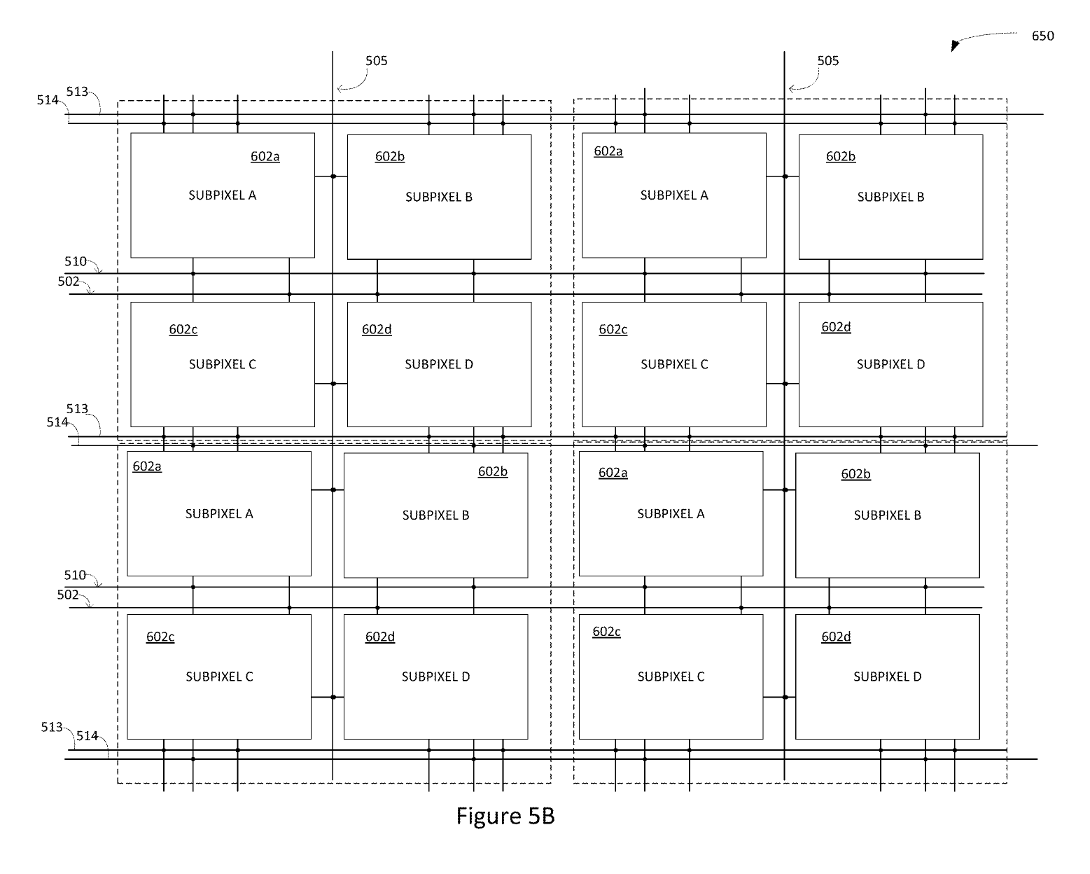

The pixel circuit 500 can be used as a building block to form a multi-sub-pixel pixel circuit similar to the pixel circuit 350 shown in FIG. 3B. An example of such a multi-sub-pixel pixel circuit is shown in FIG. 5A.

FIG. 5A shows a schematic diagram of another example pixel circuit 600. FIG. 5B shows an example control matrix 650 formed from an array of the pixel circuits 600 shown in FIG. 5A. The pixel circuit 600 include four sub-pixels 602a-602d (each generally a “sub-pixel 602”). As such, each pixel circuit 600 can cause the pixel it controls to switch to one of five different states in any given image frame (or subframe). That is, the pixel can either have 0, 1, 2, 3, 4 shutters open in any given image frame (or subframe).

Each sub-pixel 602 includes a sub-pixel circuit substantially similar to the pixel circuit 500 shown in FIG. 4A. Each of the sub-pixel circuits couples to a shared data interconnect 505 and shared scan-line interconnect 502. As shown in FIG. 5B, the data interconnect 505 passes through the middle of each pixel circuit 500 in a column of a display, and thus is shared by all pixels and sub-pixels 602 in the column. The shared scan-line interconnect 502 likewise passes through the center of each pixel circuit 500 in a row of a display, and thus is shared by all pixels and sub-pixels 602 in a given row of a display.

Still referring to FIGS. 5A and 5B, the pixel circuit 600 also includes an actuation voltage interconnect 510, a global update interconnect 514, and a shutter common interconnect 513. Each of these interconnects can be shared by sub-pixels 602 in pixels in multiple rows and multiple columns, or, in some implementations, all pixels, of the display. As shown in the pixel circuit 600 and in the control matrix 650, the actuation voltage interconnect 510 passes through the center of each pixel along a given row. With this configuration, all of the sub-pixel circuits in the pixel circuit 600 couple to the same actuation voltage interconnect 510. In contrast, the global update interconnect 514 and the shutter common interconnect 513 stretch across the display between pixels, parallel to the scan-line interconnects 502. As such, these interconnects 513 and 514 couple to sub-pixels 602 in adjacent rows.

As indicated above, each sub-pixel circuit is substantially similar to the pixel circuit 500 shown in FIG. 4A. That is, the sub-pixel circuits includes respective write-enabling transistors 604a-604d, data storage capacitor 606a-606d, charge transistors 608a-608d, discharge transistors 612a-612d, and light modulators 616a-616d. These components are interconnected and connected to the scan-line interconnect 502, the data interconnect 505, the actuation voltage interconnect 510, the global update interconnect 514, and the common shutter interconnect 513 in a similar fashion as shown with respect to the corresponding components in the pixel circuit 500 of FIG. 4A. In some other implementations, the sub-pixel circuits of a given pixel may share a common write enabling transistor 604 and a common data storage capacitor 606.

The components, other than the discharge transistors 612a-612d, are substantially identical in each sub-pixel The discharge transistors 612a-612d vary with respect to their threshold voltages. Each discharge transistor 612a-612d, however, can have a different threshold voltage such that a single data voltage can selectively control how many of the light modulators coupled to the pixel circuit 600 will change states for any given image frame (or subframe). To illustrate the operation of the pixel circuit 600, an example is described below in detail. Note that the values of the threshold voltages of various transistors provided below may be different in other implementations.

In the current example, the discharge transistor 612a in a first sub-pixel 602a has a threshold voltage of about 1.5V; the discharge transistor 612b in a second sub-pixel 602b has a threshold voltage of about 3.0V; the discharge transistor 612c in a third sub-pixel 602c has a threshold voltage of about 4.5V; and the discharge transistor 612d in the fourth sub-pixel 602d has a threshold voltage of about 6.0V. In such a configuration, a data voltage stored on the data storage capacitors 606a-606d of about 3.0V will (after application of a global actuation voltage to the global actuation interconnect 514) turn the discharge transistors 612a and 612b in the first and second sub-pixels 602a and 602b ON, thereby releasing the voltage stored on the light modulators 616a and 616b. As a result, the light modulators 616a and 616b will return to their unactuated states. The light modulators 616c and 616d will retain the voltages stored on them, and remain in an actuated state. Similarly, if a voltage of about 4.5V were stored on the data storage capacitors 606a-606d, the discharge transistors 612a-612c in sub-pixels 602a-602c would turn ON, allowing the light modulators 616a-616c to de-actuate. Storing a voltage on the data storage capacitors 606a-606d greater than or equal to 6.0V would cause all of the light modulators 616a-616d to de-actuate.

While the above example assumes a nominal 1.5V difference between discharge transistor 612a-612d threshold voltages, a person of ordinary skill in the art would appreciate that the threshold voltages could be larger or smaller depending on various factors, such as the precision of the data drivers and the reliability of the thin-film fabrication processes used to fabricate the various transistors in the pixel circuit. Similarly, a person of ordinary skill would appreciate that similar pixel circuits could be created having fewer than four or more than four sub-pixels, depending on, for example, the minimum feature size limitations of the fabrication process used to manufacture a display including the pixel circuits and the desired resolution of the display.

In addition, a person of ordinary skill in the art would appreciate that the sub-pixel circuits shown in FIG. 5A are just examples of a wide variety of sub-pixel circuits that can incorporate transistors having varying threshold voltages. In some other implementations, sub-pixel circuits can include additional circuitry for controlling a second actuator incorporated into each light modulator 516 or 616 for moving the shutter in a second direction.

In some such implementations, each sub-pixel circuit can be substantially identical to that shown in FIG. 5A, except for the addition of a second, unswitched (other than at a voltage source) actuation interconnect, which is shared by the sub-pixels in pixels in multiple rows and multiple columns of a display. In such implementations, a second actuation voltage can be applied to the unswitched actuation interconnect after the voltage is lowered on the global update interconnect 514, which, as described above allows the selective discharge of an initial actuation voltage stored on the light modulators 616 based on the data voltage stored on their respective data storage capacitors 606. The second actuation voltage, when applied to the second actuator, actively moves all light modulators from which the initial actuation voltage was discharged into a second state.

In some other implementations, the sub-pixel circuits can include more complex latches or other cross-coupled circuitry for controlling the state of each light modulator 616. In such implementations, similar to the sub-pixel circuits shown in FIG. 5A, the state of the latch or cross-coupled circuitry in each sub-pixel circuit of a given pixel can be governed by transistor having a different threshold voltage.

Referring specifically to FIG. 5B, the control matrix 650 shows four pixels 601 of a display apparatus. As a person of ordinary skill would readily appreciate, an actual display apparatus would include hundreds to millions of pixels 601. As set forth above, each pixel 601 includes the pixel circuit 600 shown in FIG. 5A. Accordingly, each pixel includes four sub-pixels 602a-602d. Data interconnects 505 pass through the middle of pixels 601 in each column of pixels 601. Two sub-pixels 602 of each pixel 601 are located on either side of each data interconnect. Similarly, scan-line interconnects 502 and actuation interconnects 510 pass through the middle of pixels 601 in each row of pixels 601, with sub-pixels 601 of each pixel on either side of each scan-line interconnect 502.

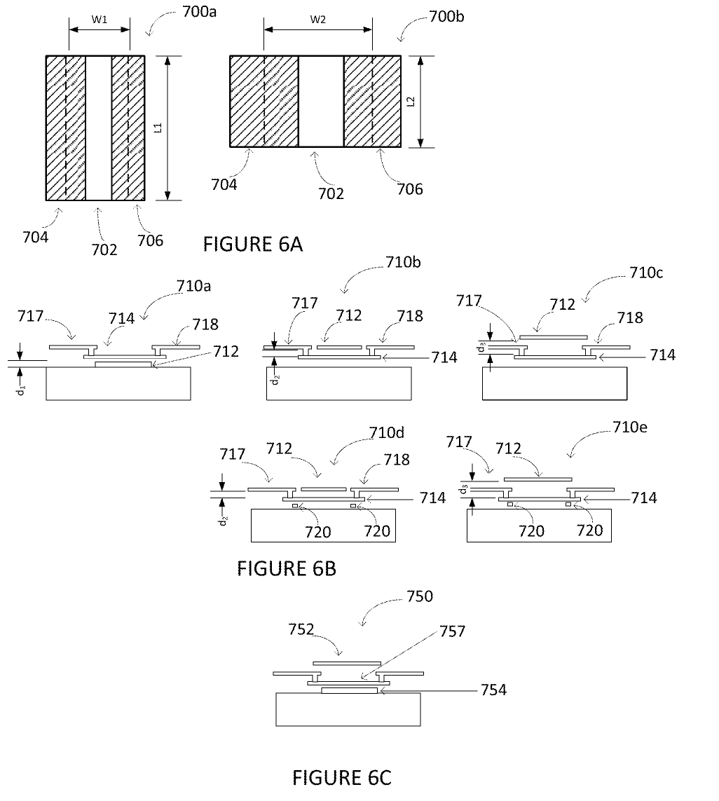

FIGS. 6A-6C show various views of example transistor architectures. In particular, the transistor architectures shown in FIGS. 6A-6C are suited for providing different threshold voltages for different transistors in a given pixel circuit. The threshold voltages of the transistors shown in FIG. 6A vary based on the length to width ratio of the channels incorporated into the transistor. The threshold voltages of the transistors shown in FIG. 6B vary based on the distance provided between the respective gates and channels of the transistors shown in the Figure. The transistor shown in FIG. 6C is a dual-gate transistor. The threshold voltage of the dual-gate transistor depends on the bias voltage applied to one of its two gates.

Referring back to FIG. 6A, FIG. 6A shows two transistors 700a and 700b having substantially different channel dimensions. Specifically, each transistor includes a channel 702, a source 704, a drain 706, and a gate (not shown). The threshold voltage of a transistor is based in part on the length to width ratio of its channel. In general, transistors having a lower length to width ratio tend to have higher threshold voltages, whereas transistors having a higher length to width ratio tend to have lower threshold voltages. For example, the channel 702 of the transistor 700a has a substantially greater length to width (L1:W1) ratio than the length to width (L2:W2) ratio of the channel 702 of the transistor 700b. Accordingly, all other things being equal, the threshold voltage of the transistor 700a would be lower than the threshold voltage of the transistor 700b. In this fashion, a pixel circuit can provide different threshold voltage transistors by forming its transistors to have channels having different relative dimensions.

FIG. 6B shows another example technique for providing transistors with different threshold voltages. Another factor in the threshold voltage of a transistor is the distance between its gate and its channel. FIG. 6B shows five transistors 710a-710 (each generally a “transistor 710”). Each transistor 710 includes a gate 712, a channel 714, a source 716, and a drain 718. The distances between the gates 712 and channels 714 of the transistors 710a, 710b, and 710c, are different resulting in transistors having different threshold voltages. More particularly, the transistor 710a is a bottom gate transistor, with a gate 712 separated from its channel 714 by a first distance, d₁, corresponding to the thickness of an intervening dielectric layer (not shown).

The transistors 710b and 710c are top gate transistors. In the transistor 710b, the gate 712 is formed from the same layer of metal as the source 716 and the drain 718 of the transistor 710b, referred to as the M2 or second metal layer. The gate 712 of the transistor 710b is separated from the channel 714 by a distance, d₂, corresponding to the thickness of a second dielectric layer (not shown). In transistors formed with metal oxide channels, the thickness of the dielectric between the channel 714 and the layer of metal that forms the source 716 and drain 718 of the transistor is typically greater than the thickness of the dielectric layer below the channel 714. That is, d₂ would typically be greater than d₁. As a result, all other things being equal, the threshold voltage of the transistor 710a would be less than the threshold voltage of the transistor 710b.

The transistor 710c introduces an even greater distance, d₃, between its gate 712 and its channel 714. Specifically, the transistor 710c includes a gate 712 formed in a metal layer deposited above the metal layer including the source 716 and drain 718, i.e., above the second metal layer. This third metal layer, referred to as the M3 layer, is separated from the second metal layer M2 by yet another layer of dielectric material (not shown). Thus, the distance d₃, in some implementations, is equal the sum of the thicknesses of the two intervening layers of dielectric material and the thickness of the second metal layer. Accordingly, the transistor 710c has a threshold voltage that is greater than the threshold voltage of the transistor 710b.

The transistors 710d and 710e are alternative implementations of the transistors 710b and 710c. The transistors 710d and 710e each include additional gate material 720 in the first metal layer, referred to as the M1 layer. The additional gate material 720 is located below the channel 714, in positions below the source 716 and drain 718 of the transistors 710d and 710e, substantially spanning at least the distance between where the source 716 or drain 718 contacts the channel 714 and the edge of the source 716 or drain 718 closest to the gate 712. This additional gate material 720 is electrically tied to the gate 712 and counters any shielding effect the source 716 or drain 718 may have on the channel with respect to a voltage applied to the gate 712.

In some implementations, the transistors 710a-710e include conductive oxide (such as indium gallium zinc oxide (IGZO)) or low-temperature polysilicon (LTPS) channels.

FIG. 6C shows a dual-gate transistor 750 which may be used to provide varying threshold voltages in a pixel circuit. The dual-gate transistor 750 includes two independently controlled gates 752 and 754, located above and below its channel 756. By adjusting the voltages applied to one of the gates 752 or 754, the voltage needed to be applied to the other of the gates 752 or 754 to turn on the transistor 250 can be raised or lowered. For example, applying a positive voltage to the one the gates 752 or 754 reduces the voltage needed to be applied to the other of the gates 752 or 754 to turn ON the transistor 750. Applying a negative voltage to the gates 752 or 754 increases the voltage needed to be applied to the other of the gates 752 or 754 to turn ON the transistor 750.

In some implementations, the channel 756 of the transistor 750 can be formed from an metal oxide, such as IGZO.

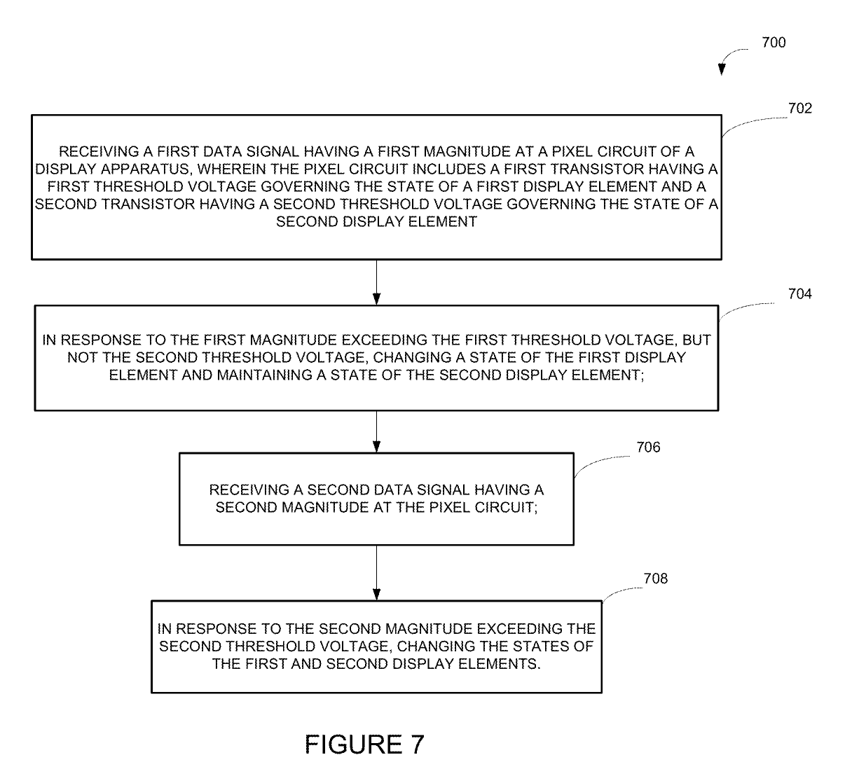

FIG. 7 shows a flow diagram of an example method 700 of controlling a pixel of a display apparatus. The method can be used, for example, to control a pixel, such as the pixel 302 shown in FIG. 3A or the pixel 601 shown in FIG. 5B, having pixel circuits similar to the pixel circuit 350 shown in FIG. 3B or the pixel circuit 600 shown in FIG. 5A. The method 700 includes receiving a first data signal having a first magnitude at a pixel circuit of a display apparatus (stage 702). In some implementations, the pixel circuit includes a first transistor having a first threshold voltage governing the state of a first display element and a second transistor having a second threshold voltage governing the state of a second display element. In response to the first magnitude exceeding the first threshold voltage, but not the second threshold voltage, the method 700 includes changing a state of the first display element and maintaining a state of the second display element (stage 704). The method further includes receiving a second data signal having a second magnitude at the pixel circuit (stage 706). In response to the second magnitude exceeding the second threshold voltage, the method 700 includes changing the states of the first and second display elements (stage 708). In some implementations, the second threshold voltage is about twice the first threshold voltage. As described above in relation to the operation of the pixel circuits 350 and 600, the data signal and the first and second transistors, in some implementations, can govern the state of the first and second display elements by selectively applying or discharging an actuation voltage to or from the first and second display elements.

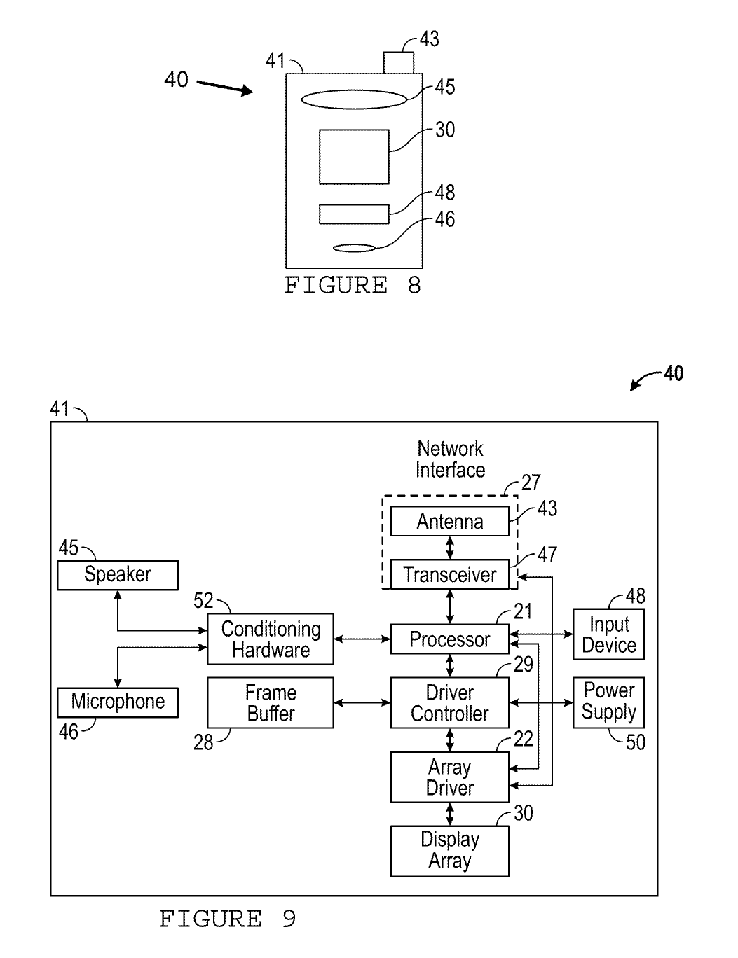

FIGS. 8 and 9 show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
an array of pixels, wherein each pixel includes a plurality of light modulators;
a control matrix coupled to the array of pixels, wherein the control matrix includes for each pixel:
a first transistor having a first threshold voltage governing actuation of a first light modulator of the plurality light modulators in the pixel;
a second transistor having a second threshold voltage, different than the first threshold voltage, governing actuation of a second light modulator of the plurality light modulators in the pixel; and
a single data interconnect providing a common data voltage to corresponding gates of both the first and second transistors.

2. The apparatus of claim 1, wherein the application of a data voltage greater than the first threshold voltage and less than the second threshold voltage causes the actuation or discharge of the first light modulator but not the second light modulator.

3. The apparatus of claim 2, wherein the application of a data voltage greater than the first and second threshold voltages causes the actuation or discharge of both the first and second light modulators.

4. The apparatus of claim 1, wherein the first and second light modulators include electromechanical systems (EMS) shutters which are configured to move relative to separate apertures formed in a light blocking layer.

5. The apparatus of claim 1, wherein for a given pixel, the first transistor is included in a first sub-pixel circuit and the second transistor is included in a substantially identical second sub-pixel circuit.

6. The apparatus of claim 5, wherein the control matrix includes an actuation interconnect coupled to the first and second sub-pixel circuits.

7. The apparatus of claim 6, wherein at least one of the data interconnect and the actuation interconnect passes between the first and second sub-pixel circuits.

8. The apparatus of claim 1, wherein the first transistor includes a gate formed at a first metal layer of the control matrix and the second transistor includes a gate formed at a second metal layer of the control matrix other than the first metal layer.

9. The apparatus of claim 1, wherein at least one of the first and second transistors includes a dual-gate metal oxide transistor, and wherein the difference between the first threshold voltage and the second threshold voltage is based on a voltage applied to one of the gates of the dual gate metal oxide transistor.

10. The apparatus of claim 1, wherein the length to width ratio of a channel included in the first transistor is substantially different than a length to width ratio of a channel included in the second transistor.

11. The apparatus of claim 1, further comprising:
a display including the array of pixels;
a processor that is configured to communicate with the display, the processor being configured to process image data; and
a memory device that is configured to communicate with the processor.

12. The apparatus of claim 11, the display further including:
a driver circuit configured to send at least one signal to the display; and
a controller configured to send at least a portion of the image data to the driver circuit.

13. The apparatus of claim 11, the display further including:
an image source module configured to send the image data to the processor, wherein the image source module comprises at least one of a receiver, transceiver, and transmitter.

14. The apparatus of claim 11, the display further including:
an input device configured to receive input data and to communicate the input data to the processor.

15. An apparatus, comprising:
an array of display elements;
a control matrix coupled to the array of display elements, wherein the control matrix includes for each display element:
a first transistor having a first threshold voltage governing application of an actuation voltage to the display element; and
a second transistor having a second threshold voltage, lower than the first threshold voltage, governing discharge of the actuation voltage from the display element.

16. The apparatus of claim 15, wherein the control matrix includes an actuation voltage interconnect coupled to the drain and the gate of the first transistor.

17. The apparatus of claim 15, wherein the control matrix includes for each display element a data storage capacitor configured to store a data voltage received via a data interconnect for controlling the state of the second transistor.

18. The apparatus of claim 15, wherein the first transistor includes a gate formed at a first metal layer of the control matrix and the second transistor includes a gate formed at a second metal layer of the control matrix other than the first metal layer.

19. The apparatus of claim 15, wherein at least one of the first and second transistors includes a dual-gate metal oxide transistor, and wherein the difference between the first threshold voltage and the second threshold voltage is based on a voltage applied to one of the gates of the dual gate metal oxide transistor.

20. The apparatus of claim 15, wherein the length to width ratio of a channel included in the first transistor is substantially different than a length to width ratio of a channel included in the second transistor.

21. A method of controlling a display apparatus pixel, comprising:
receiving a first data signal having a first magnitude at a pixel circuit of a display apparatus, wherein the pixel circuit includes a first transistor having a first threshold voltage governing the state of a first display element and a second transistor having a second threshold voltage governing the state of a second display element;
in response to the first magnitude exceeding the first threshold voltage, but not the second threshold voltage, changing a state of the first display element and maintaining a state of the second display element;
receiving a second data signal having a second magnitude at the pixel circuit; and
in response to the second magnitude exceeding the second threshold voltage, changing the states of the first and second display elements.

22. The method of claim 21, wherein the second threshold voltage is about twice the first threshold voltage.

23. The method of claim 21, wherein receiving the first and second data signals includes receiving the first and second data signals on a single data interconnect.

24. The method of claim 21, further comprising receiving at the first pixel an actuation voltage, wherein the magnitude of the received data voltage selectively governs the application or discharge of the actuation voltage to the first and second display elements
